(19) United States
(12) Patent Application Publication
(10) Pub. No.: US 2007/0156510 A1
(43) Pub. Date: Jul. 5, 2007

(54) METHODS AND SYSTEMS FOR DETERMINING RELIABILITY OF PRODUCT DEMAND FORECASTS

(76) Inventors: Edward Kim, Toronto (CA); Jean-Philippe Vorsanger, Toronto (CA); Jinsheng Gao, North York (CA); Mazhar Khan, Markham (CA)

Correspondence Address: JAMES M. STOVER;NCR CORPORATION, 1700 SOUTH PATTERSON BLVD, WHQ4, DAYTON, OH, 45479, US

(21) Appl. No.: 11/614,258

(22) Filed: Dec. 21, 2006

Related U.S. Application Data
(60) Provisional application No. 60/755,462, filed on Dec. 30, 2005.

(51) Int. Cl. G06F 17/30

(52) U.S. Cl. 705/10

(57) ABSTRACT

A method has been devised to produce a Confidence Prediction metric which gives the business user some indication as to the future reliability of the current week's forecast. The forecasting method analyzes historical demand data and prior product demand forecasts to calculate forecast errors for the prior product demand forecasts, and determine a confidence level for current and future product demand forecasts, the confidence level providing an indication of whether a given product forecast is unreliable or not. Reliable product demand forecasts can be automatically passed to a purchase order system, while unreliable forecasts may need to be reviewed and adjusted manually. A method for assessing, before-hand, whether a given product's forecast is reliable has been devised.

### FIELD OF THE INVENTION

The present invention relates to methods and systems for forecasting product demand for retail operations, and in particular to the determination of a confidence of reliability level for product demand forecasts.

### BACKGROUND OF THE INVENTION

Accurately determining demand forecasts for products are paramount concerns for retail organizations. Demand forecasts are used for inventory control, purchase planning, work force planning, and other planning needs of organizations. Inaccurate demand forecasts can result in shortages of inventory that are needed to meet current demand, which can result in lost sales and revenues for the organizations. Conversely, inventory that exceeds a current demand can adversely impact the profits of an organization. Excessive inventory of perishable goods may lead to a loss for those goods.

Inferior forecasting science and gut feel decisions on inventory have created significant stock-out conditions across the industry. Recent studies quantify stock-outs in the retail industry at 5 to 8%, while overstock conditions caused by poor forecasts and ordering decisions continue to climb.

This challenge makes accurate consumer demand forecasting and automated replenishment techniques more necessary than ever. A highly accurate forecast not only removes the guess work for the real potential of both products and stores/distribution centers, but delivers improved customer satisfaction, increased sales, improved inventory turns and significant return on investment.

Teradata, a division of NCR Corporation, has developed a suite of analytical applications for the retail business, referred to as Teradata Demand Chain Management, that provides retailers with the tools they need for product demand forecasting, planning and replenishment. As illustrated in FIG. 1, the Teradata Demand Chain Management analytical application suite 101 is shown to be part of a data warehouse solution for the retail industries built upon NCR Corporation's Teradata Data Warehouse 103, using a Teradata Retail Logical Data Model (RLDM) 105. The key modules contained within the Teradata Demand Chain Management application suite 103, organized into forecasting and planning applications 107 and replenishment applications 109, are:

Demand Forecasting: The Demand Forecasting module 111 provides store/SKU (Stock Keeping Unit) level forecasting that responds to unique local customer demand. It continually compares historical and current demand and utilizes several methods to determine the best product demand forecast.

Seasonal Profile: The Seasonal Profile module 113 automatically calculates seasonal selling patterns at all levels of merchandise and location. The module draws on historical sales data to automatically create seasonal models for groups of items with similar seasonal patterns. The model may also incorporate the effects of promotions, markdowns and items with different seasonal tendencies.

Contribution: Contribution module 117 provides an automatic categorization of SKUs, merchandise categories and locations by contribution codes. These codes are used by the replenishment system to ensure the service levels, replenishment rules and space allocation are constantly favoring those items preferred by the customer. SKUs are ranked based on percent of sales units, sales dollars or gross margin they represent.

Promotions Management: The Promotions Management module 119 automatically calculates the precise additional stock needed to meet demand resulting from promotional activity.

Automated Replenishment: Automated Replenishment module 121 provides the retailer with the ability to manage replenishment both at the distribution center and the store level. It employs user-defined business policies that assist merchandising teams in achieving business objectives. The replenishment calculations consider business policies, service levels, forecast error, risk stock, review times and lead times.

Time Phased Replenishment: Time Phased Replenishment module 123 provides a weekly long-range order forecast that can be shared with vendors to facilitate collaborative planning and order execution. Logistical and ordering constraints such as lead times, review times, service-level targets, min/max shelf levels, etc. can be simulated to improve the synchronization of ordering with individual store requirements.

Allocation: The Allocation module 125 determines distribution of products from the warehouse to the store.

The Teradata Demand Chain Management suite of products solution described above models historical sales data to forecast future demand of products. The forecasting system is designed to forecast future demand based upon the sales data of a retailer. The retailer typically has millions of combinations of weekly forecasts of products in stores in which to assess whether they are “good” forecasts or not. The good or reliable forecasts can be automatically passed to a purchase order system, while unreliable forecasts may need to be reviewed and adjusted manually. A method for assessing, before-hand, whether a given product forecast is unreliable or not is desired.

### BRIEF DESCRIPTION OF THE DRAWINGS

FIG. 1 provides an illustration of a forecasting, planning and replenishment software application suite for the retail industries built upon NCR Corporation's Teradata Data Warehouse.

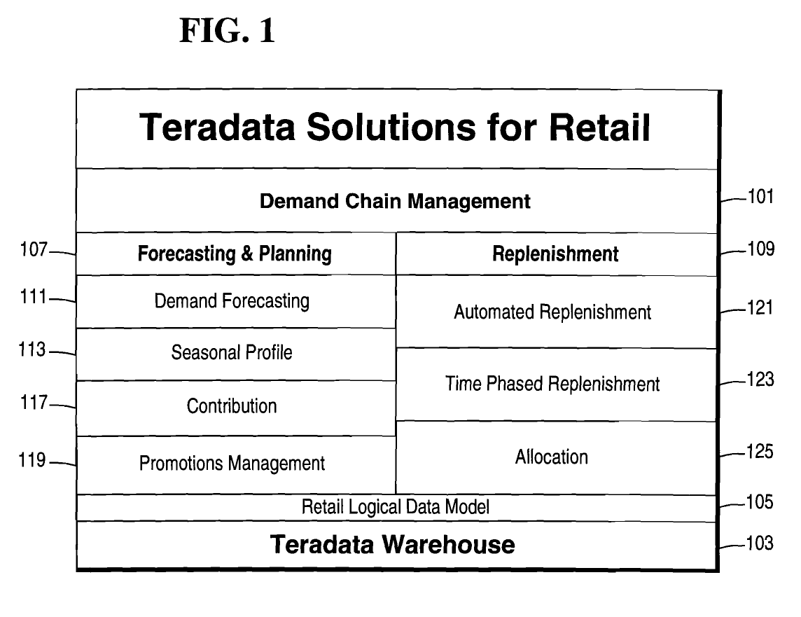

FIG. 2 provides a histogram illustrating the frequency of forecast errors for a high volume selling product.

FIG. 3 provides a histogram illustrating the frequency of forecast errors for a low volume selling product.

FIG. 4 is a flow diagram illustrating the method for determining Confidence Prediction numbers in accordance with the present invention.

FIG. 5 provides a histogram illustrating the distribution of Outliers and Non-Outliers across the range of Confidence Prediction numbers.

### DETAILED DESCRIPTION OF THE INVENTION

In the following description, reference is made to the accompanying drawings that form a part hereof, and in which is shown by way of illustration specific embodiments in which the invention may be practiced. These embodiments are described in sufficient detail to enable one of ordinary skill in the art to practice the invention, and it is to be understood that other embodiments may be utilized and that structural, logical, optical, and electrical changes may be made without departing from the scope of the present invention. The following description is, therefore, not to be taken in a limited sense, and the scope of the present invention is defined by the appended claims.

As stated above, the Teradata Demand Chain Management (TDCM) suite of products models the historical sales data to forecast future demand of products, however, it is not obvious how to assess before-hand whether a given product forecast is unreliable or not. NCR Corporation has devised a Confidence Prediction metric for the DCM solution which provides the business user with an indication as to the future reliability of a current week's product demand forecast. The Confidence Prediction metric comprises a number ranging from −1.0 to +1.0, the more negative the number, the more unreliable the forecast. Conversely, the more positive the number, the more reliable is the forecast.

Determination of Confidence Prediction metrics for regular and promotional forecasts involves: (1) recognizing that forecast errors are lognormally distributed, (2) using normalized historical errors to mine the regression coefficients needed to model the average (or expected) errors for the given range of sales volumes, and (3) using the Product Variance Rule in combining random processes to arrive at the total expected error for Promotional Forecasts. The combination of these mathematical methods produces a Confidence Prediction metric that can then be used by a retailer to assess the reliability of a product forecast.

Forecast Confidence is typically given by an Interval and Level. For example, a 95% Confidence (Level) that actual will be within ±20% of Forecast (Interval). With a demand forecast of one hundred (100) units, the interpretation is that there is 95% chance that actual sales will be between 80 and 120.

The general approach to determining forecast confidence is as follows. Assume X₁, X₂, . . . X_{N} are forecast errors for a forecast process Yᵢ for the past N weeks or days. The average of Xᵢ's˜0; that is, the errors are both positive and negative and average out to 0. The variance of Xᵢ's=Sₓ². At week N+1, the Confidence Limit for the forecast is given by:
Y_{N+1}±t_{(N-1,1-α/2)}*sqrt(Sₓ²/N),
where t represents an approximation of the normal distribution, and (1−α) represents the Confidence Level.

For a given Confidence Interval (e.g ±20% of forecast), the forecast Confidence Level (100*(1−α))% can be computed. For example, for a Confidence Level of 90%, α=0.10, (1−α/2)=0.95. If N=10, then Y₁₁±t_{(9,0.95)}*sqrt(Sₓ²/10).

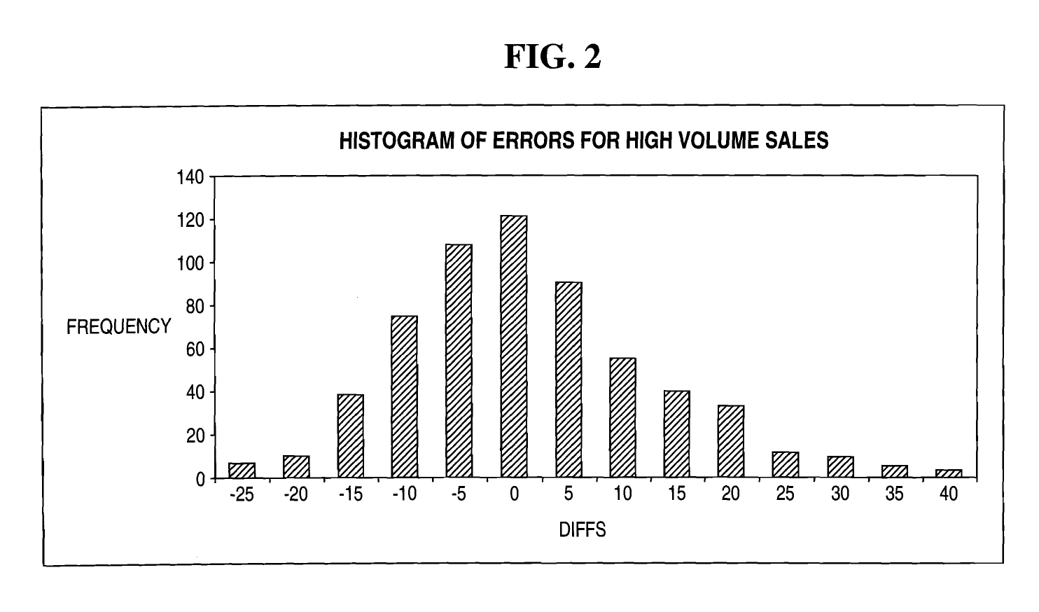

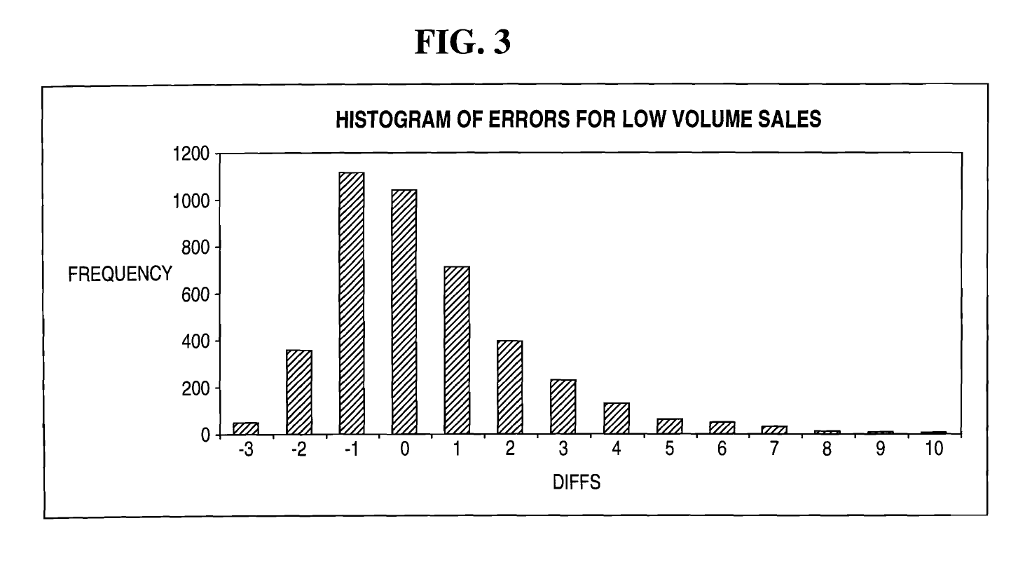

Forecast Confidence is dependent on previous forecast errors, sales volume (velocity), and the scarcity of product demand/sales data in recent weeks. All these factors are combined into the confidence calculation. Furthermore, it is known that forecast errors for lower selling products are not Normally (Gaussian) distributed. A high selling product with average weekly sales of 100 units may sell in a range between 80 and 120 units in any given week, as illustrated in FIG. 2. However, a low selling product with average weekly sales of 3 units may sell in a range between 0 and 10 units in any given week, as illustrated in FIG. 3. This skewed distribution is called a lognormal distribution. As stated earlier, normality is needed for using the Confidence Prediction formula.

The standard way to transform a lognormal distribution to a normal distribution is to take the Natural Logarithm of the Error Ratio, LN(Fcst/Demand). For example, a forecast of 100 units which actually sold 80 units has the following Log Error Ratio: LN(100/80)=0.223. For a forecast of 1 unit, which actually sold 3 units, the Log Error Ratio: LN(1/3)=−1.1. This procedure makes the errors normally distributed for high and low volume sales.

The DCM system stores up to thirteen weeks of historical forecasts which can be used to calculate Weekly and Daily Confidence Levels for each Store and SKU combination. Use of the same Confidence Interval for Weekly and Daily (e.g. ±20%) which would result in different Confidence Levels (e.g. 90% for the Weekly forecast and 60% for the Daily forecast). Same, or close, Confidence Levels for Weekly and Daily forecasts (e.g. 90%) would require different Confidence Intervals (e.g. ±20% for Weekly and ±40% for Daily).

Confidence Levels can be provided for Weekly Regular Forecast, Daily Regular Forecast, Weekly Total Forecast and Daily Total Forecast. Business Rules around Confidence Level can be defined and used to generate exceptions, automate replenishment, or trigger reviews and actions.

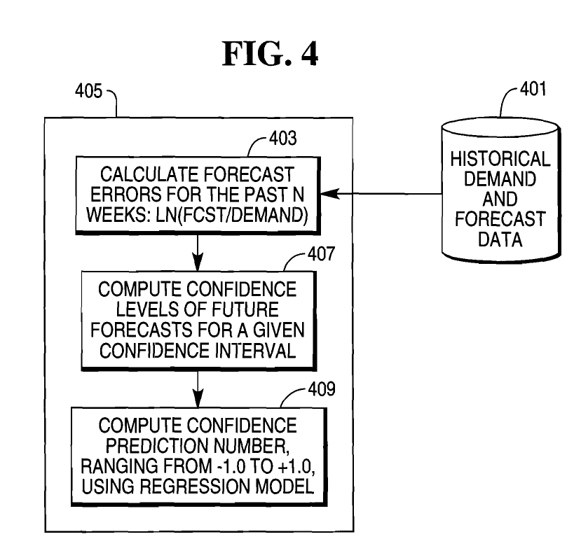

FIG. 4 illustrates the process executed within the Teradata DCM solution 403 for determining the Confidence Prediction number for regular demand forecasts. Determination of the Confidence Prediction number involves the retrieval of historical data from database 401 and the calculation of forecast errors for the past N weeks (or days) by taking the Log of the Error Ratio (step 405), computation of Confidence Levels of the future forecasts for a given Confidence Interval (step 407), and computation of the Confidence Prediction number, ranging from −1.0 to +1.0, using a regression model (step 409).

The DCM system generates a promotional demand forecast by multiplying a regular demand forecast by an uplift coefficient. For example, a regular, or baseline, demand forecast of 100 units with an uplift of 2.5 gives a promotional forecast of 250 units. The promotional Uplift Coefficient also has some uncertainty and measurable error. That error is also a lognormally distributed variable with a variance or standard deviation. Letting Z represent the Promotional Uplift Coefficient variable, then the mean Avg[Z]=Z′, and the variance Var[Z]=S_{z}². Since Promotional Forecast(Y)=Uplift(Z)*Baseline(X), the variance of the Promotional Forecast is Var[Y]=Var[Z*X].

The business user can set a cutoff threshold, PredConf, to filter the set of products (SKUs) into reliable forecast SKUs and unreliable forecast SKUs. For instance, if the threshold was set to PredConf<0.0, there may be 40% of the SKUs identified as the top 40% most unreliable forecasts. If the threshold is set to PredConf<0.1, then the top 60% most unreliable SKUs would be identified. If the threshold is set to PredConf<−0.1 then the top 25% of the most unreliable SKUs would be identified. By extension, a filter threshold of PredConf<−1.0 will return 0 records, and a PredConf<1.0 will return all records.

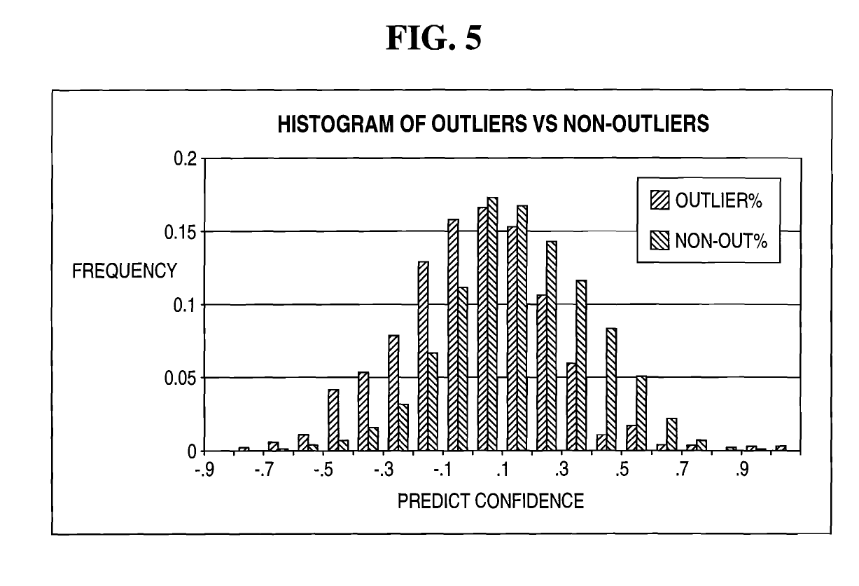

The reason why this Confidence Prediction metric is a statistically significant predictor of outliers—data points well outside of expected values—and unreliable forecasts is because their distributions are different than non-outliers, as shown in the Histogram graph of FIG. 5.

Referring to FIG. 5, the distribution of outliers (blue bars) is negatively skewed and centered around −0.1, while the non-outliers'distribution is slightly positive skewed and centered around +0.1. This means the user of this metric can set a threshold, for example 0.0, to mark as many outliers as possible while minimizing the number of marking non-outliers. Obviously, there is a tradeoff between catching a high percentage of outliers and marking a low percentage of overall SKUs. The users will have to find the optimal threshold which most advantageous for their application.

The reason why so many SKUs have to be identified as potentially unreliable is because in any given week, a small percentage of those unreliable may be Outliers, but from one week to the next, a different set of outliers may be found. Some tests indicate that only 13% of outliers in one week are repeat outliers in the following week. For example, in a set of 100,000 SKUs, there may be 4500 SKUs (4.5%) which were found to be outliers in week1. In week2, there may be another 4700 SKUs which were outliers. However, there were only 600SKUs which were outliers in both weeks. Thus, there were at least 8600 SKUs (=4500+4700−600) that were unreliable in those two weeks. Over 10 weeks or several months, this effect becomes compounded and the set of potentially unreliable SKUs become quite large. Since we cannot say when a particular SKU is going to be an outlier, a large portion of total SKUs need to be identified as potentially unreliable in order to cover as many outliers in a given week

Note, the forecast error alone is not a good predictor of future reliability. The forecast error is historical reporting metric and may not be indicative of future outliers. Also, the PredConf metric can be generated for all SKUs, but the reliability of this is much better with high and medium volume SKUs. For low volume SKUs, selling on average less than one unit per week, the metric is somewhat less effective since the sparse selling patterns makes nearly all the products unreliable to forecast.

In summary, the Predict Confidence metric is a number ranging from −1.0 to +1.0 which gives a reliability of a product demand forecast. The user will have to set a threshold which will optimally yield a set of unreliable SKUs for their application. While a threshold of 0.0 will optimally segment the set such that there will be a minimal percentage of unreliable SKUs left in the reliable set, it is recommended that the user try thresholds ranging from −0.3 to +0.3 to find the top X % of SKUs that the user would like to consider unreliable.

What is claimed is:

1. A method for forecasting product demand for a product, the method comprising the steps of:
maintaining a database of historical product demand information;
periodically analyzing said historical product demand information for said product to determine a demand forecast for said product;
saving said periodic demand forecasts;
comparing said periodic demand forecasts with actual demand information contained within said database for a selected number of corresponding historical forecast periods;
calculating forecast errors for said selected historical forecast periods; and
determining a confidence level of future forecast periods from the forecast errors for said historical forecast periods;

2. The method for forecasting product demand for a product in accordance with claim 1, wherein:
said forecast errors are calculated by dividing the periodic demand forecasts by the corresponding historical demand information for said selected periods; and
said confidence level is determined in accordance with the equation:
Y_{N+1}±t_{(N-1,(1-α)/2)}*sqrt(Sₓ²/N), where:
Y_{N+1} is a forecast process for N forecast periods;
t represents an approximation of a normal distribution;
(1−α) represents the confidence level; and
Sₓ² represents the variance of the forecast errors.

3. The method for forecasting product demand for a product in accordance with claim 1, wherein:
said forecast periods comprise weekly forecast periods.

4. The method for forecasting product demand for a product in accordance with claim 1, further comprising the steps of:
comparing said confidence level to a predetermined confidence level value; and
identifying a product forecast as unreliable when said confidence level exceeds said predetermined confidence level value.

5. In a computerized method for forecasting product demand for a product, the improvement comprising the steps of:
calculating forecast errors for prior product forecasts for said product; and
determining a confidence level of a product forecast from said forecast errors.

6. The method for forecasting product demand for a product in accordance with claim 5, further comprising the steps of:
comparing said confidence level to a predetermined confidence level value; and
identifying a product forecast as unreliable when said confidence level exceeds said predetermined confidence level value.

7. The method for forecasting product demand for a product in accordance with claim 5, wherein:
said confidence level is determined in accordance with the equation:
Y_{N+1}±t_{(N-1,(1-α)/2)}*sqrt(Sₓ²/N), where:
Y_{N+1} is a forecast process for N forecast periods;
t represents an approximation of a normal distribution;
(1−α) represents the confidence level; and
Sₓ² represents the variance of the forecast errors.
